(19) United States
(12) Patent Application Publication
(10) Pub. No.: US 2002/0183662 A1
(43) Pub. Date: Dec. 5, 2002

(54) Veins and arteries massager

(76) Inventors: Shun-Tsung Lu, Taichung (TW); Ta-Wei Lui, Brea, CA (US)

Correspondence Address: Raymond Y. Chan, 1050 Oakdale Lane, Arcadia, CA, 91006, US

(21) Appl. No.: 10/099,521

(22) Filed: Mar. 15, 2002

Related U.S. Application Data
(63) Continuation-in-part of application No. 09/873,149, filed on Jun. 4, 2001.

(51) Int. Cl. A61H 7/00

(52) U.S. Cl. 601/28

(57) ABSTRACT

A veins and arteries massager, which can make the user stand by the way that the location of the tiptoe is higher than that of the heel according to ergonomics, achieves the function of massage veins and arteries, comprising a base whereof the end portion is bent vertically upwardly to serve as a stopper, a pedal board joined above the base having a joined end which is pivoted to the base at the position near the stopper and a free end which can rotate respectively to the base, a pair of massage pads set on the pedal board for users, and a support for sustaining the free end of the pedal board such that the pedal board can be maintained at an oblique pose with positioning the free end at the location higher than the location of the joined end.

### CROSS REFERENCE OF RELATED APPLICATION

The present invention is a Continuation-in-part (CIP) application of a pending non-provisional patent application with application No. 09/873,149 filed on Jun. 04, 2001.

### BACKGROUND OF THE INVENTION

1. Field of the Invention

The present invention relates to a fitness equipment, especially to a veins and arteries massager which allows the user to stand obliquely with the location of the tiptoe higher than the location of the heel, according to ergonomics.

2. Description of the Prior Art

Modern life is so nervous and busy that the many people suffer from some civilized sickness, especially for those who have to sit in the office working for a long period, those having long office hours, or those typing the computer, driving the car or airplane for a long time, or those under rehabilitation, or the aged, or travelers, the related diseases about veins and arteries are more serious. However, these diseases caused by nervous life, long-term improper sitting pose, or surgical operation can be improved effectively through adequate sport and activation of veins and arteries which can promote the blood circulation, even without medication. Modem people usually lack adequate sport. Therefore, how to design a sports and fitness equipment to promote the blood circulation and loose the physique, occupying little space and easy to use is the first object of related industry.

However, general fitness equipments not only occupy enormous space but also have a huge weight. Therefore, the equipment is often located at a fixed position indoor, and can't be brought with someone for using such that the usage space and usage time are limited. In this way, the equipment can't be a popular fitness equipment for all people. Moreover, conventional fitness equipments only allow the user to take exercise of part of muscle but not promote the blood circulation and make tiredness disappear. Therefore, the conventional fitness equipments are difficult to correspond to the usage requirement of the general people.

The inventor of the present invention has focused on the theorem of the way to keep in good health for several years, and finally succeeded in inventing the present invention, a veins and arteries massager.

### SUMMARY OF THE INVENTION

The first purpose of the present invention is to provide a veins and arteries massager, which allows the user to stand on according to the principle of a lever such that the effect of extending tendon of the lower legs can be achieved. Besides, the function of promoting the blood circulation and making the spine upright can be achieved, and the internal organs, such as a kidney or a pelvis, of the user can be activated via conditioning the standing pose with inclined foot thenars.

The second purpose of the present invention is to provide a veins and arteries massager which can provide the thenar and ankle of feet with a vibrating massage effect to promote the blood circulation and reduce aches of legs due to excess exercise.

The other purpose of the present invention is to provide a veins and arteries massager, which is simple in structure, small in volume, and light in weight such that it is not only easy to be folded with occupying little space but also easy to be brought with the user. In this way, the present invention is easy for those who have to sit in the office working for a long period, those who have to drive or type the computer for a long period, airplane passengers, long-distance travelers, those after a surgical operation and the common people to use inside the house, vehicle, or airplane, or use outdoor without limitation of time and space. Besides, the present invention can also serves as the warm-up equipment before taking violent exercise for a sportsman or the common people.

A veins and arteries massager which can achieve the purposes described above comprises a base whereof the end portion is bent vertically upwardly to serve as a stopper, a pedal board joined above the base having a joined end which is pivoted to the base at the position near the stopper and a free end which can rotate with respect to the base, a pair of massage pads set on the pedal board for users, and a support for sustaining the free end of the pedal board such that the pedal board can be maintained at a oblique pose with positioning the free end at the location higher than the location of the joined end.

### BRIEF DESCROPTION OF THE DRAWINGS

The drawings disclose an illustrative embodiment of the present invention which serves to exemplify the various advantages and objects hereof, and are as follows:

FIG. 1 is the three-dimensional schematic diagram of the veins and arteries massager provided from the present invention;

FIG. 2 is the three-dimensional decomposed diagram of the veins and arteries massager;

FIG. 3 is the lateral view of the veins and arteries massager when used;

FIG. 4˜FIG. 6 are the partial lateral views of the pedal board of the veins and arteries massager at different inclined angles;

FIG. 7 is the partial lateral view of the pedal board of the veins and arteries massager when folded; and

FIG. 8 is the lateral cutaway view of another practice example of the veins and arteries massager provided from the present invention.

### DETAILED DESCRIPTION OF THE PREFERRED EMBODIMENT

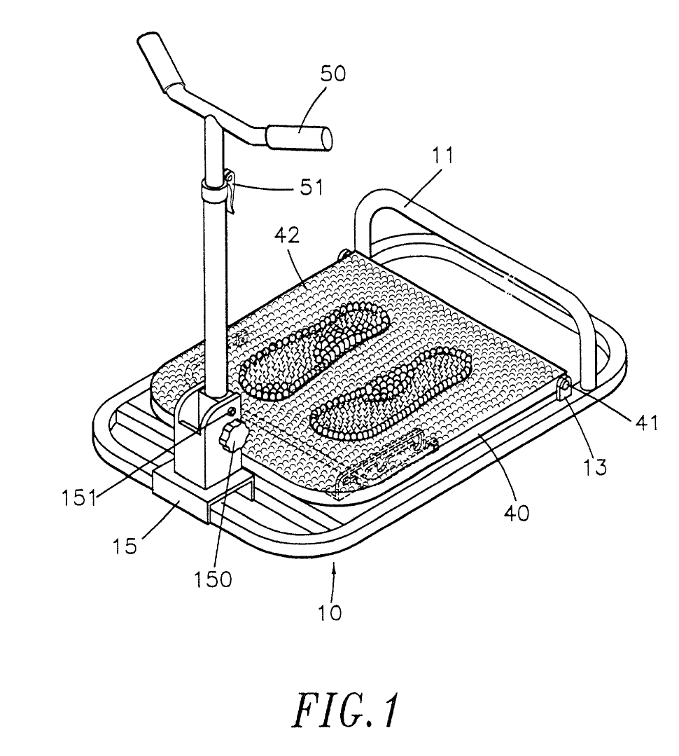

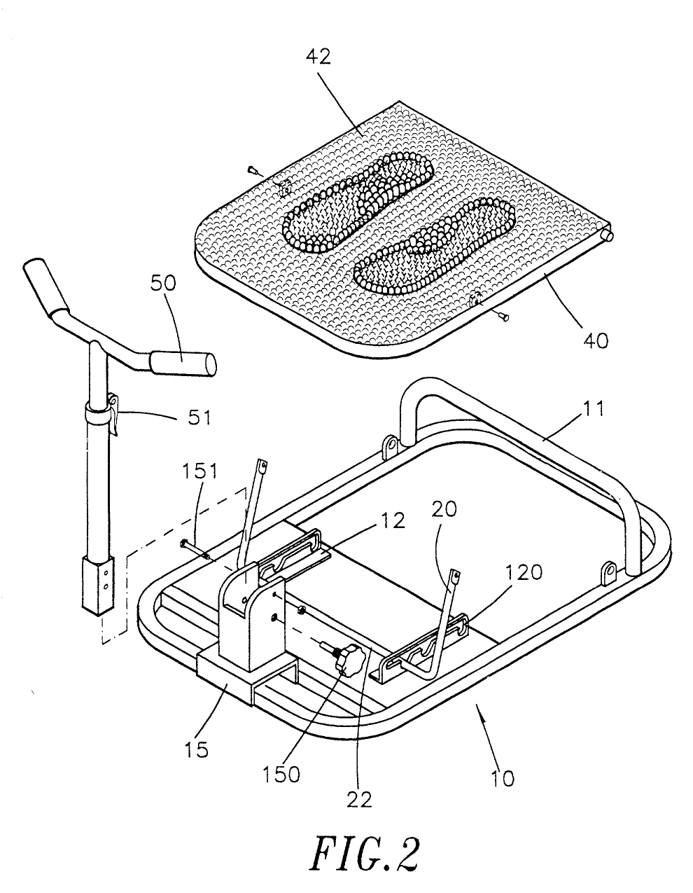

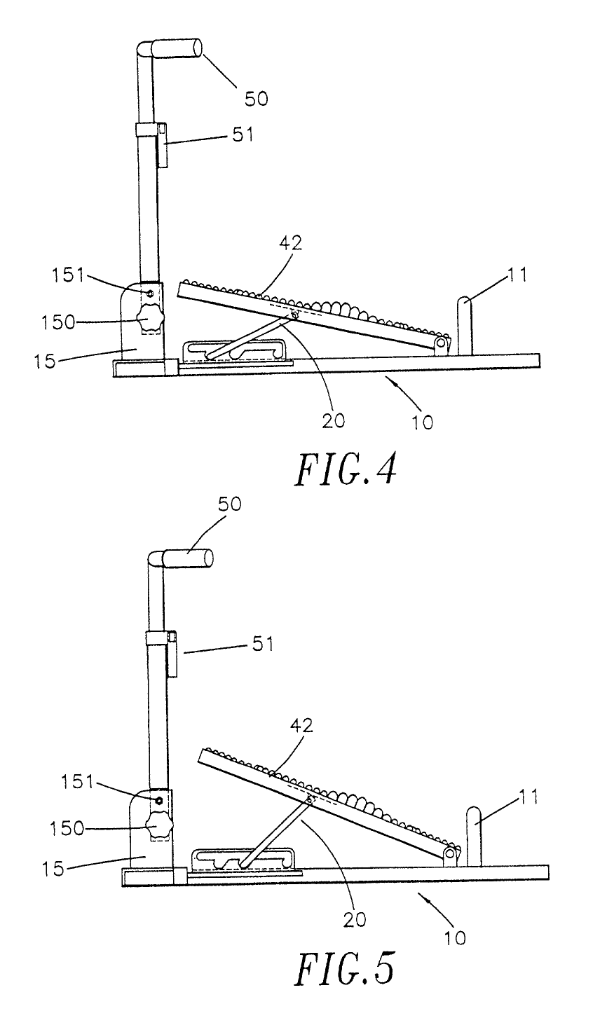

Referring to FIG. 1 and FIG. 2 simultaneously, a veins and arteries massager provided from the present invention comprises a base 10, whereof the end portion is bent vertically upwardly to serve as a stopper 11, a pair of pivot ears 13 extended upward from the base 10 at the location near the stopper 11 of both sides and used for joining with a pedal board 40, the pedal board 40 having a pivot end 44 which is pivoted on the pivot ears via a pair of secure pins 41 of both sides to make the free end of the pedal board 40 can rotate about the pivot, in other words, can be near to or be distant from the base 10, a support 20 which is pivoted under the pedal board 40 at the front end away from the pivot ears 13. The support 20 is [symbol] -form, and both ends 21 of two sides are extended and plugged into the pedal board 40 such that the support 20 can rotate relative to the pedal board 40. Several position parts 12 are set vertically at the front end of the base 10, and the free end 22 of the support 20 can be chosen to be moved into one of engaging holes 120 set on the position parts 12 to make the pedal board 40 is held in the way that the position of the front end is higher than that of the rear end by using the support 20 such that the pedal board 40 is positioned at a inclined pose having a certain angle of inclination as shown in FIG. 4˜FIG. 6.

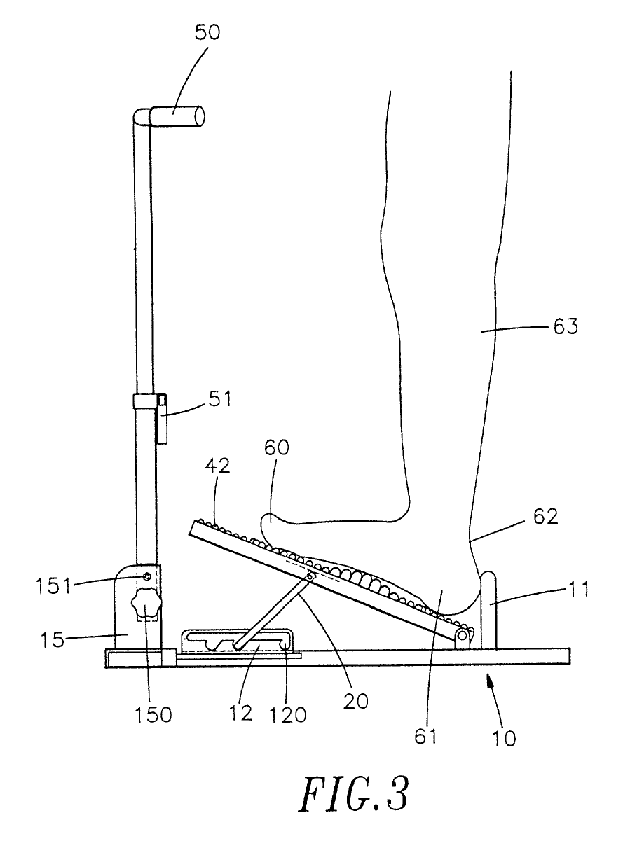

As shown in FIG. 3, the user stand on the pedal board 40 by the way that the position of the tiptoe 60 is higher than that of the that of the heel. The stopper 11 is used for blocking the ankle 62 from that the user slips outward from the pedal board 40 and allowing the lower leg 63 of the to keep in upright state. Unlike the normal condition, the user stands with the foot thenar being in inclined state, so there is an effect of stretching tendon to smooth the veins and arteries, and force the spine to upright. Besides, by conditioning the standing pose resulted from the oblique thenar, internal organs of the body, such as a kidney and a pelvis, can be activated.

A safety board 14 for presenting from facing upward is extended rearward from the end portion of the base 10 such that the bottom area can be increased when the massager is placed on the ground. Therefore, the user standing obliquely on the veins and arteries massager can be prevented from turning over resulted from an external force.

An extruded massage pad 42 is set flatly on the surface of the pedal board 40. More than one extruded pellets 43 on the massage pad 42 provide the massaging function for the feet thenar of the user standing on the massage pad 42, and stimulate the acupuncture points to promote the blood circulation.

An armrest seat 15 is set at the front end of the upper surface of base 10, and is used for receiving, setting and adjusting height of an armrest 50. Besides, a safety screw 150 and a fastening pin 151 are used to fastening the armrest 15 for ensuring the steady effect when the user stands on the massager and the safety of the user, and the usage of freely receiving and setting the armrest 15.

A fastening knob 51 is set on the armrest 50 for conditioning the height of the armrest 50 due to the height of the user. When the user is pushed, or isn't used to stand on the massager obliquely, or the center of gravity is unstable, the user can place the hand on the armrest for avoid from falling down.

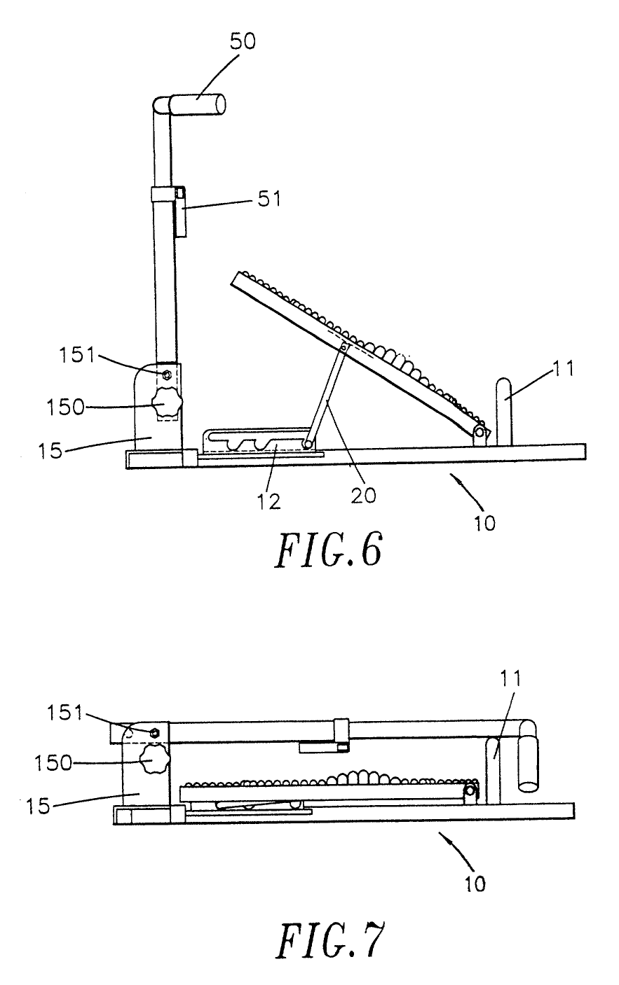

As shown in FIG. 7, when the veins and arteries massager is not used, the support 20 can be rotate to in the horizontal state and the free end 22 thereof can be placed on the upper surface of the base 10 such that the pedal board 40 can also be in horizontal state to be placed on the upper surface of the base 10 because losing support force of the support 20. Besides, a commonly used clip can be used to clip the pedal board 40 with the base 10 by a releasable method. Besides, the way of folding the armrest 50 is to first loose the safety screw 150, then turn the armrest 50 rearward about the fastening pin 151 for 90 degrees.

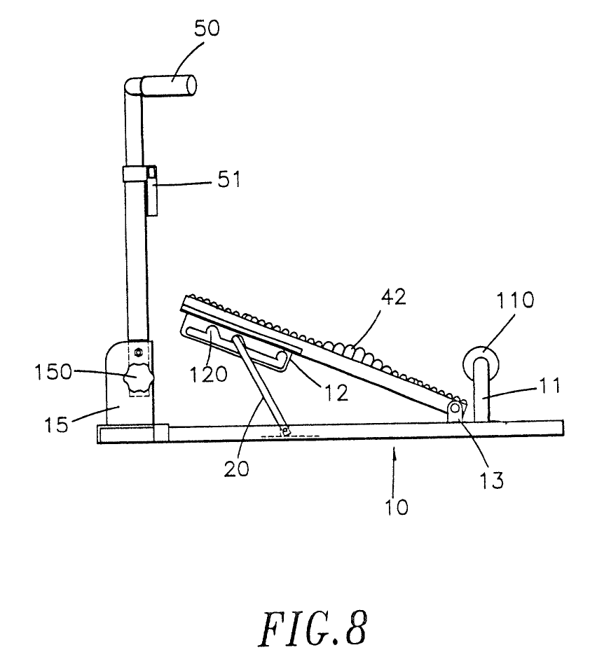

Please referring to FIG. 8, which is another practice example of the veins and arteries massager provided from the present invention, a soft rubber sleeve 110 is slipped on the stopper 11 to prevent the ankle 62 of the user from getting hurt when the ankle is leaned against the stopper 11.

Comparing with commonly used fitness equipments, the veins and arteries massager has following advantages:

1) The present invention makes the user stand on the pedal board 40 by the way that the location of the tiptoe 60 is higher than that of the heel and the stopper is used for blocking the ankle such that the lower leg is kept in upright state to have an effect of stretching tendon to smooth the veins and arteries, and force the spine to upright. Besides, by conditioning the standing pose resulted from the oblique thenar, internal organs of the body, such as a kidney and a pelvis, can be activated;

2) the present invention provides the vibrating massaging function for the feet thenar of the user to promote the blood circulation and reduce the ache due to taking excessive exercise; and

3) a veins and arteries massager provided from the present invention is simple in structure, and smaller in volume, and lighter in weight than general fitness equipments on sale such that it is not only easy to be folded and placed with occupying little space but also easy to be brought with the user. In this way, the present invention is easy for those who have to sit in the office working for a long period, those who have to drive for a long period, long-distance travelers, and the common people to use inside the house, vehicle, or use outdoor without limitation of time and space.

Many changes and modifications in the above described embodiment if the invention can, of course, be carried out without departing from the scope thereof. Accordingly, to promote the progress in science and the useful arts, the invention is disclosed and is intended to be limited only by the scope of appended claims.

What is claimed is:

1. A veins and arteries massager, comprising:
a base, whereof a end portion is bent upward vertically to serve as a stopper;
a armrest seat, which is set at a front end of said base for setting a armrest;
a pedal board pivoted above said base, whereof a pivoted end is pivoted on said base near said stopper and a free end can rotate respectively to said base;
a support, which is used for supporting and fixing said free end of said pedal board to make said pedal board positioned at a oblique pose with said free end being higher than said pivoted end.

2. A veins and arteries massager as recited in claim 1, wherein a plurality of first position parts are set on said base, an first end of said support being pivoted on said pedal board while an second end of said support can be chosen to be moved and fixed in any engaging hole of said first position parts.

3. A veins and arteries massager as recited in claim 1, wherein a plurality of second position parts are set on said pedal board, an first end of said support being pivoted on said base while an second end of said support can be chosen to be moved and fixed in any engaging hole of said second position parts.

4. A veins and arteries massager as recited in claim 1, wherein a retractable safety board is extended rearward from a rear end of said base.

5. A veins and arteries massager as recited in claim 1, wherein a massage pad is set on said pedal board.

6. A veins and arteries massager as recited in claim 1, wherein an armrest is inset on said base, height of said armrest being adjustable.

7. A veins and arteries massager as recited in claim 1, wherein a safety screw can be set on said armrest seat.

8. A veins and arteries massager as recited in claim 1, wherein a fastening pin can be set on said armrest seat to make said armrest foldable.

9. A veins and arteries massager as recited in claim 1, wherein a soft rubber sleeve can be slipped on said stopper.
